(19) United States
(12) Patent Application Publication
(10) Pub. No.: US 2013/0102177 A1
(43) Pub. Date: Apr. 25, 2013

(54) ELECTRICAL CONTACT WITH REDUNDANT CONTACT POINTS

(71) Applicant: Ohio Associated Enterprises, LLC, Painesville, OH (US)

(72) Inventors: John T. Venaleck, Painesville, OH (US); Alan L. Roath, Madison, OH (US)

(73) Assignee: OHIO ASSOCIATED ENTERPRISES, LLC, Painesville, OH (US)

(21) Appl. No.: 13/657,211

(22) Filed: Oct. 22, 2012

Related U.S. Application Data
(60) Provisional application No. 61/549,927, filed on Oct. 21, 2011.
(60) Provisional application No. 61/549,921, filed on Oct. 21, 2011.

(51) Int. Cl. H01R 13/28

(52) U.S. Cl. 439/295

(57) ABSTRACT

An electrical connection between hermaphroditic contacts includes redundant contact points. Each of the contacts may have ridges on bent or curved portions, for making contact with straight portions of the other contact. The ridges may be parallel to one another. The mating allows both pairs of contact points to be maintained even when there is some misalignment between the contacts, due to beam rotation caused by torsional compliance. The connection provides great reliability.

This application claims priority to U.S. Provisional Applications 61/549,927 and 61/549,921, both filed Oct. 21, 2011, and both of which are incorporated herein by reference in their entirety.

### FIELD OF THE INVENTION

This invention is in the field of electrical contacts.

### DESCRIPTION OF THE RELATED ART

Various types of electrical interconnection systems are known. Exemplary interconnection systems include those which are used to connect one or more electrical conductors on one printed circuit board or card to one or more respective electrical conductors on another printed circuit board or card. Other types of exemplary interconnection systems are those used to connect one or more conductors of an electrical cable to one or more respective electrical conductors of another cable, a printed circuit card or board, a terminal, etc. Other types of electrical interconnection systems also are known.

A disadvantage encountered in prior board to board interconnection systems has been the relatively large amount of space required for the connectors, both on and between the respective boards, thus consuming space in an apparatus in which the boards are used and the lateral space required on the board, sometimes referred to as real estate. It is desirable to minimize the space requirements for interconnection systems.

Other disadvantages in prior electrical interconnection systems encountered due to contact design include variations in insertion forces, a need for large insertion forces to assure strong electrical connections between contacts, interruption in electrical continuity due to dirt between confronting contact surfaces, wearing of contacts due to sharp burrs and the like on the contact metal, etc.

In conventional non-hermaphroditic electrical connectors for use in various electrical interconnection systems plural parts, one typically being referred to as a male part and one as a female part, had to be designed, engineered, and manufactured. Typically a male electrical connector would have one type of contact and one type of housing; and a female electrical connector would have a different type of electrical contact and housing designed to mate with the male. The housings support the contacts, often provide protection and alignment functions for the contacts, and even guide one connector to connection with the other. Such housings also help to hold themselves and the contacts thereof in electrical interconnection engagement with each other.

The more separate parts required for the electrical interconnection system, the more designing, engineering and manufacturing time, effort, and cost are required to complete the interconnection system and the larger the number of parts typically required for adequate inventory supply.

### SUMMARY OF THE INVENTION

In the field of dies designed to bend sheet metal parts, a common design utilized is a match metal die in which both the inside radius of the bend and the outside radius of the bend is ordered. When the part is manufactured, the die exerts enough force to yield the materiel in the bend and sets the bend to the shape desired. If, however, a beam with a rectangular section is bent around a male mandrel such that the inside radius is ordered, but the bend is free and not confined, the materiel yields and a distortion of the section forms which has two raised bumps distal from one another along the major axis of the section on the tension side. These raised areas can be utilized as a redundant contact points in an electrical connection provided certain geometries are utilized. First, the mating contact must have a side with the same width to receive the redundant contact points. Second, the beams that constitute the compliant members of the contact pair must be sufficiently torsionaly compliant to allow rotation caused by one bump coming in contact before the other. If a small angular misalignment exists because of manufacturing tolerance or the like, then the torsional compliance will allow beam rotation until the second bump comes in contact with the mating beam, after which a load sharing will occur. For a reliable electrical contact, the load on the weak side should be at least 40 grams. Since a typical total normal force is 100 grams, then the strong side would be 60 grams. This 60/40 split would be typical in a well-designed contact. A perfect contact would, of course, share the loads 50/50.

One aspect of this invention provides that two points of contact formed at the bend of a beam with rectangular section mated with a beam of like section forms a redundant contact path.

Another aspect of the invention provides that torsional compliance of the beam pair be at least 20 grams times the section width for 0.2 degrees total deflection or 0.1 degrees per beam.

Still another aspect of the invention teaches that hermaphroditic contacts formed of like beams will have 4 points of contact for the electrical path with load sharing of 60 to 40-percent, if the beam length is greater than 15 times the beam thickness and the thickness to width ratio of the beam in 2:1, and the rotational misalignment is less than 0.5 percent of the total deflection of the beam in use.

According to yet another aspect of the invention, a reliable electrical contact design takes advantage of a naturally occurring distortion of the contact metal when bent to form redundant contact points.

According to still another aspect of the invention, an electrical connection includes: a first hermaphroditic electrical contact; and a second hermaphroditic electrical contact mated to the first hermaphroditic electrical contact. Each of the electrical contacts has a straight portion and a bent portion, with the bent portion having a pair of protruding contact ridges parallel to each other, oriented along a length of the electrical contact. When the electrical contacts are mated, one or both of the contact ridges of the bent portion of the first electrical contact are in contact with the straight portion of the second electrical contact. When the electrical contacts are mated, one or both of the contact ridges of the bent portion of the second electrical contact are in contact with the straight portion of the first electrical contact.

According to a further aspect of the invention, a method of making electrical connection includes mating hermaphroditic electrical contacts. The mating includes electrically connecting the contacts using two pairs of redundant contact points.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily to scale, show various aspects of the invention.

FIG. 1 is a side view of a hermaphroditic contact pair, mated together.

FIG. 2A is sectional view through a straight portion of one of the contacts of FIG. 1.

FIG. 2B is a sectional view through a bent portion of one of the contacts of FIG. 2.

FIG. 3 is a sectional view showing contact between the bent portion of one of the contacts of FIG. 1, and a straight portion of the other of the contacts.

FIG. 4 is a sectional view showing contact between a bent portion and a straight portion, with some misalignment.

FIG. 5 is a side view showing mating connector parts that include the contact pair of FIG. 1.

### DETAILED DESCRIPTION

An electrical connection between hermaphroditic contacts includes redundant contact points. Each of the contacts may have ridges on bent or curved portions, for making contact with straight portions of the other contact. The ridges may be parallel to one another. The mating allows both pairs of contact points to be maintained even when there is some misalignment between the contacts, due to beam rotation caused by torsional compliance. The connection provides great reliability.

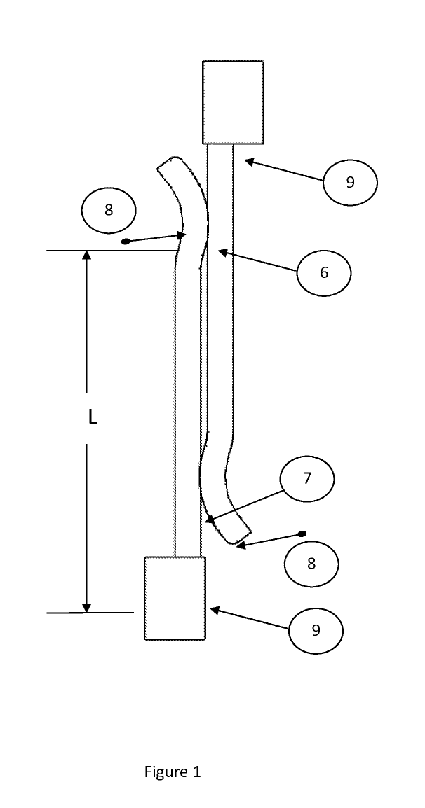

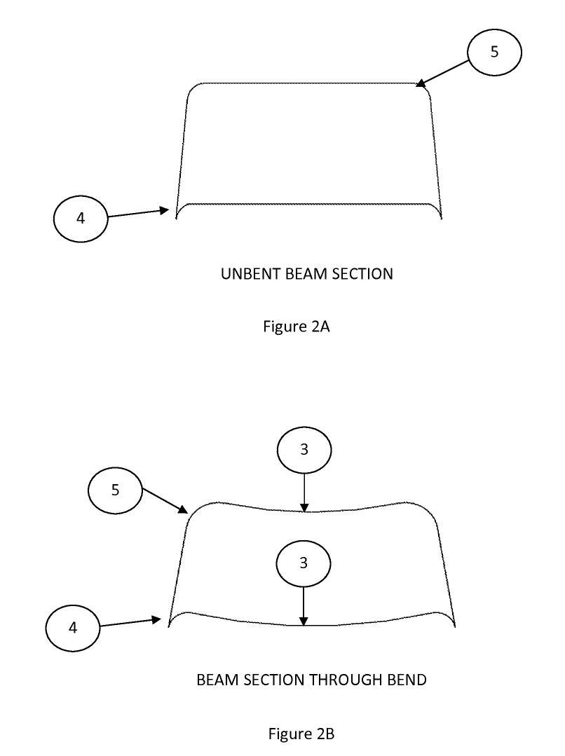

FIG. 1 shows a hermaphroditic contact pair mated for carrying electrical current. The points of electrical contact are at (6) and (7). The contacts are made of a suitable electrically-conductive material, such as copper. The elastic beam is L long and is fixed at its base (9) and has a functional bend (8). The bend (8) serves to provide lead in at beginning engagement and also provides the possibility of redundant contact points. In fact, properly done, this arrangement will yield four (4) separate and redundant contact points (or contact ridges) providing superior reliability. FIG. 2A shows the unbent section of the compliant beam in an as-sheared condition. The features are greatly exaggerated for clarity. The slope of the side between contact points (4) and (5) is the result of the die clearance. Contact point (4) is on the punch side of the die and forms a burr as shown. The opposite side has a smooth radius at the boundary formed by elastic deformation during stamping.

The bases (9) may be made of a suitable dielectric material, such as a suitable plastic. The bases (9) may be enclosed by or secured to headers or other portions of the connector parts. The mating contact pairs may be in one or more rows of the connector. The connector may be any of a variety of types of connectors, such as for connecting a cable to an electrical board, an electrical board to another electrical board, or for making other connections. Further details regarding electrical connectors having hermaphroditic contacts may be found in U.S. Pat. No. 5,098,311, the description and figures of which are incorporated herein by reference.

FIG. 2B also shows the beam section distorted by stresses when forming the bend radius (8) as shown in FIG. 1. The slope (4) to (5) is greater than in FIG. 2A since longitudinal stretching of the outer fibers will shorten the beam width at the outside of the radius; while the inside is under longitudinal compression and will grow slightly wider. The resultant curvature (3) allows for two points at (5) one left and one right, which are out of plane and constitute the high points of the contact in the bend radius.

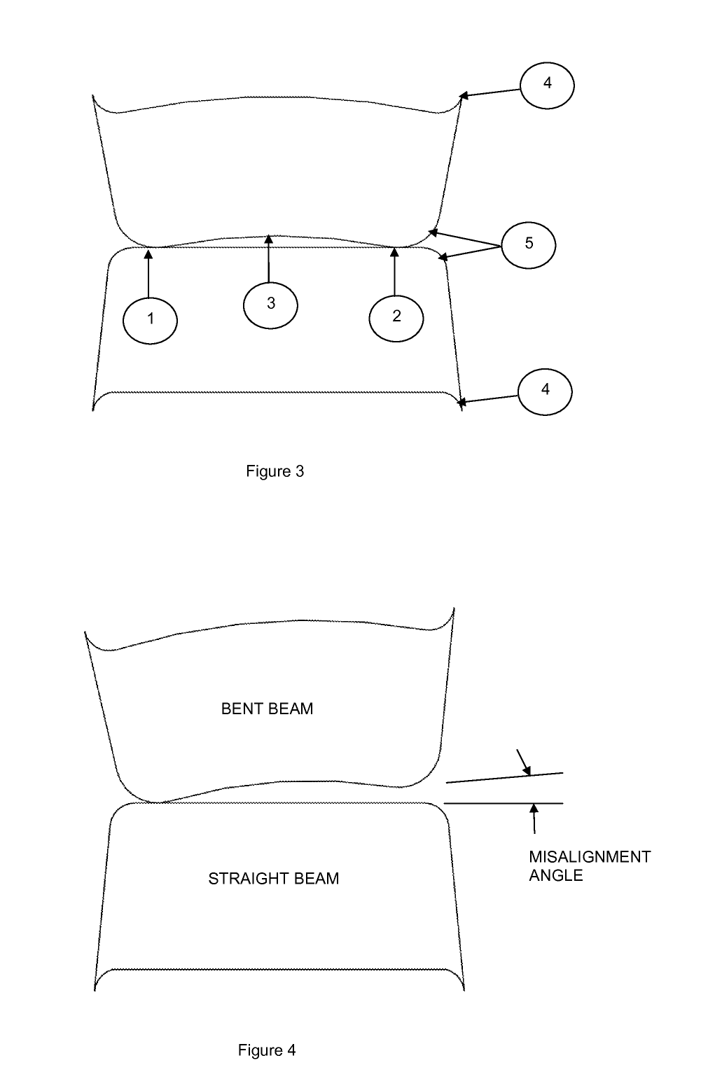

As shown in FIG. 1, the opposing contacts touch each other, bent section to flat section at (6) and (7). FIG. 3 shows the contact positions for the pair. Clearly, FIG. 3 points (1) and (2) illustrate the principle, the curvature (3) allowing (1) and (2) to contact independently.

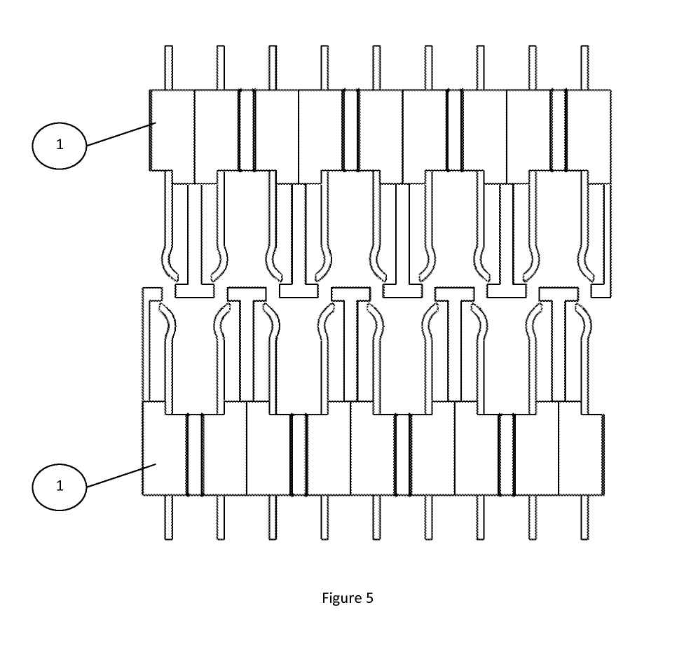

FIG. 4 shows a misalignment between a bent beam and a straight beam. As stated earlier such a small angular misalignment may exist because of manufacturing tolerance or the like. If such a small angular misalignment occurs, then the torsional compliance will allow beam rotation until the second bump comes in contact with the mating beam, producing the situation shown in FIG. 3, after which a load sharing will occur.

The contact pair shown in FIG. 1 may be part of a connector having multiple contact pairs that engage one another when mating parts of the connector are mated. FIG. 5 shows an example of a pair of such mating parts (10).

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electrical connection comprising:
a first hermaphroditic electrical contact; and
a second hermaphroditic electrical contact mated to the first hermaphroditic electrical contact;
wherein each of the electrical contacts has a straight portion and a bent portion, with the bent portion having a pair of protruding contact ridges parallel to each other, oriented along a length of the electrical contact;
wherein, when the electrical contacts are mated, one or both of the contact ridges of the bent portion of the first electrical contact are in contact with the straight portion of the second electrical contact; and
wherein, when the electrical contacts are mated, one or both of the contact ridges of the bent portion of the second electrical contact are in contact with the straight portion of the first electrical contact.

2. The electrical connection of claim 1, wherein the electrical contacts are substantially identical.

3. The electrical connection of claim 1, wherein the electrical contacts remain mated even when there is a misalignment angle between the contacts.

4. The electrical connection of claim 1, wherein the contact ridges provide redundant contact points at the contact between the bent portion of the first electrical contact and the straight portion of the second electrical contact, and between the bent portion of the second electrical contact and the straight portion of the first electrical contact.

5. The electrical connection of claim 1, wherein the contacts are parts of separate respective mating parts of an electrical connector.

6. The electrical connection of claim 1,
wherein both of the contact ridges of the bent portion of the first electrical contact are in contact with the straight portion of the second electrical contact; and
wherein both of the contact ridges of the bent portion of the second electrical contact are in contact with the straight portion of the first electrical contact.

7. The electrical connection of claim 6, wherein torsional compliance causes beam rotation of one or both of the contacts, to correct for misalignment between the contacts when the contacts are mated.

8. The electrical connection of claim 1, wherein the contacts remain electrically connected even when there is misalignment between the contacts, with a misalignment angle between the contacts.

9. The electrical connection of claim 1, wherein the bent portions have each have a bend radius.

10. The electrical connection of claim 9, wherein the bent portions have an inner width at the inside of the bend radius that is greater than an outer width at the outside of the bend radius.

11. The electrical connection of claim 1, wherein the contacts are coupled to respective dielectric material bases.

12. The electrical connection of claim 11, wherein the bases are made of a plastic.

13. The electrical connection of claim 1, wherein the contacts include copper.

14. A method of making electrical connection, the method comprising:
mating hermaphroditic electrical contacts;
wherein the mating includes electrically connecting the contacts using two pairs of redundant contact points.

15. The method of claim 14,
wherein the contacts each include a straight portion and a bent portion; and
wherein the redundant contact points are on ridges on the bent portions, that for each of the contacts make contact with the straight portion of the other contact.

16. The method of claim 15, wherein the mating includes rotating one or both of the contacts, using torsional compliance, to compensate for angular misalignment between the contacts.
